(19) United States
(12) Patent Application Publication
(10) Pub. No.: US 2020/0010269 A1
(43) Pub. Date: Jan. 9, 2020

(54) SYSTEM FOR ENCLOSING A WASTE RECEPTACLE

(71) Applicant: Kathy J. Copp, Clinton, OH (US)

(72) Inventor: Kathy J. Copp, Clinton, OH (US)

(21) Appl. No.: 16/502,753

(22) Filed: Jul. 3, 2019

Related U.S. Application Data
(60) Provisional application No. 62/694,770, filed on Jul. 6, 2018.

(51) Int. Cl. B65F 1/14; B65F 1/16

(52) U.S. Cl. CPC B65F 1/1426; B65F 1/1607

(57) ABSTRACT

A system for enclosing a waste receptacle, such as a residential trash can, to increase the aesthetic appeal of the receptacle, prevent unwanted intrusion by insects and wildlife, and contain offensive odors therein is provided. The system can allow the receptacle to be placed alongside a structure while blending into the structure. Alternatively, the system can be placed in a stand-alone environment while maintaining the aesthetic appeal of the enclosure.

### CROSS REFERENCE TO RELATED APPLICATIONS

This application claims the benefit of U.S. Provisional Application Ser. No. 62/694,770, filed on Jul. 6, 2018; the disclosure of which is incorporated herein by reference.

### BACKGROUND

### Technical Field

The present disclosure relates to an enclosure for a waste receptacle. Specifically, the present enclosure relates to a mobile and/or removable enclosure to surround and otherwise cover a waste receptacle such as a trash can. More particularly, the present disclosure relates to an aesthetically pleasing enclosure to surround the exterior of a waste receptacle to camouflage and/or hide the receptacle from view while retaining functionality of the waste receptacle.

### Background Information

Individual waste receptacles such as trash cans and recycle bins that are often used in residential neighborhoods can be unsightly and are difficult to conceal from the public eye. Additionally, as it is the nature of the contents of these cans can produce unwanted and uninvited smells; most people prefer to leave these receptacles outside of their homes and/or garages where they can be seen from the street and sidewalk. In communities where municipal waste collection is regulated by the community or contracted through the city, often these receptacles are produced in non-aesthetically pleasing colors such as bright green, dark green, or blue, or other similar shades. Many of these colors do not blend in with the neighborhood aesthetic or otherwise complement the neighborhoods and can create an eyesore to an outsider or potential purchaser, as well as to homeowners in the community.

Previous solutions tend to involve permanent structures such as fencing or other type enclosures such as walled enclosures to hide from view. These types of enclosures can be cost prohibitive and take up more space than would normally be necessary. Additionally, many of these are permanent installations that may not suit everyone's tastes including subsequent homebuyers and can be a negative on resale value for the home. Further, space dedicated to storage of waste receptacles is lost to storage of other items and/or parking space which can be valuable to the homeowner.

An additional problem that arises from the placement and storage of waste receptacles, particularly those kept outside of the home or garage, is the tendency for garbage to attract unwanted attention from insects and other wildlife. Raccoons, in particular, are known to raid trash cans that contain leftover food items and can create a large mess that is required to be cleaned and/or dealt with by the owner of the waste receptacle. It is not uncommon for raccoons to visit the same waste receptacle over a period of multiple nights leaving messes each time, alleviated only by the emptying of the waste receptacle or by securing the closure of the waste receptacle in a way that a raccoon or other wildlife is frustrated in their attempts to open it.

### SUMMARY

Provided herein is an aesthetically pleasing waste receptacle enclosure that can camouflage the waste receptacle while retaining functionality of the waste receptacle. Additionally, provided herein is a waste receptacle enclosure that can be easily secured to reduce or eliminate intrusions by insects or wildlife. An additional benefit of the enclosure provided herein is that it is light-weight and portable and capable to be used in multiple locations.

In one aspect, the present disclosure may provide a waste receptacle enclosure having: a first side panel having a first side edge, a second side edge, a top edge, a bottom edge, an inner face and an outer face; a second side panel having a first side edge, a second side edge, a top edge, a bottom edge, an inner face and an outer face, wherein the first side edge of the second panel is connected to the second side edge of the first side panel and oriented about 90 degrees thereto; a third side panel having a first side edge, a second side edge, a top edge, a bottom edge, an inner face and an outer face; wherein the second side edge of the second panel is connected to the first side edge of the third side panel and oriented about 90 degrees thereto; a lid having a first side, a second side, a third side, a fourth side, and a planar sheet connecting each of the sides, the planar sheet further having a top side and a bottom side, wherein the bottom side of the planar sheet rests upon the top edges of the first, second, and third side panels; and a waste receptacle further comprising a trash can contained therein.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1A is a front elevation view of a PRIOR ART trash can.

FIG. 1B is a front elevation view of an alternative PRIOR ART trash can.

FIG. 2A is a top left perspective view of an embodiment of the trash can enclosure of the present application.

FIG. 2B is an exploded top left perspective view of the embodiment of the trash can enclosure from FIG. 2A.

FIG. 2C is an operational front elevation cross sectional view of the embodiment of the trash can enclosure taken along the line indicated in FIG. 2A, with a PRIOR ART trash can enclosed therein.

FIG. 3A is a top left perspective view of an alternate embodiment of a lid for the trash can enclosure of the present application.

FIG. 3B is a top left perspective view of another alternate embodiment of a lid for the trash can enclosure of the present application.

FIG. 4A is a top left perspective view of an alternate embodiment of the trash can enclosure of the present application.

FIG. 4B is an exploded top left perspective view of the embodiment of the trash can enclosure from FIG. 3A.

FIG. 5 is a top left perspective view of an alternate embodiment of the trash can enclosure of the present application.

FIG. 6A is a top left perspective view of an alternate embodiment of the trash can enclosure of the present application.

FIG. 6B is an operational front elevation cross sectional view of the embodiment of the trash can enclosure from FIG. 7 with a PRIOR ART trash can enclosed therein.

FIG. 7 is a front elevation view of an alternate embodiment of a trash can enclosure of the present application.

Similar numbers refer to similar parts throughout the drawings.

### DETAILED DESCRIPTION

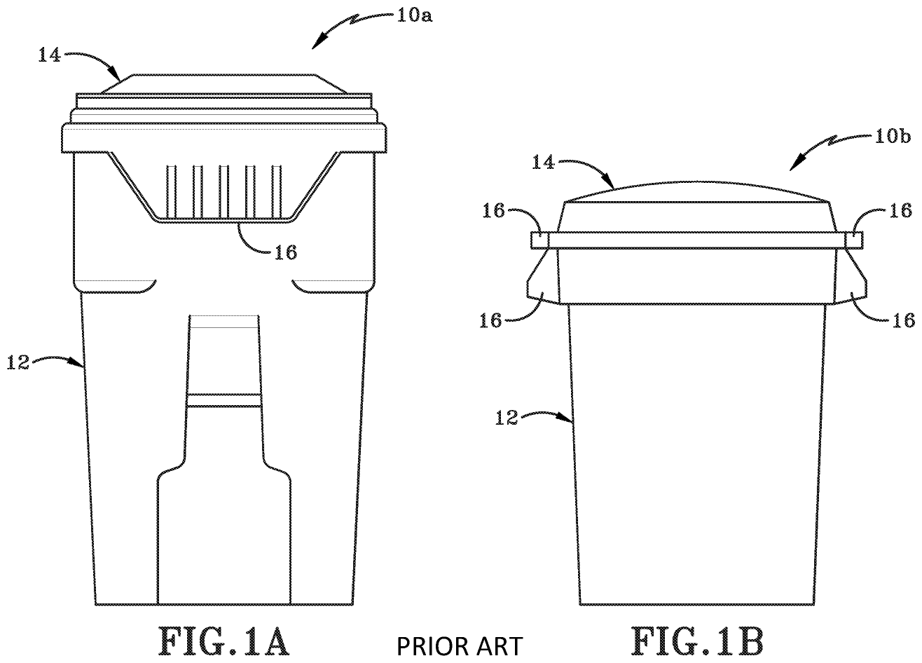

With reference to FIGS. 1A and 1B, prior art waste receptacles, hereinafter referred to as trash cans 10a and 10b (collectively referred to as trash cans 10), are shown having standard features associated with the trash cans 10. Specifically, trash can 10 can have a body 12 in which waste is disposed, lid 14, one or more handles 16, and one or more pairs of wheels (not shown). Trash cans 10 can be any standard or non-standard waste receptacle or container capable of containing refuse therein. It will be understood that some features of a trash can 10 can be omitted, such as a lid 14, handle 16, or wheels 18.

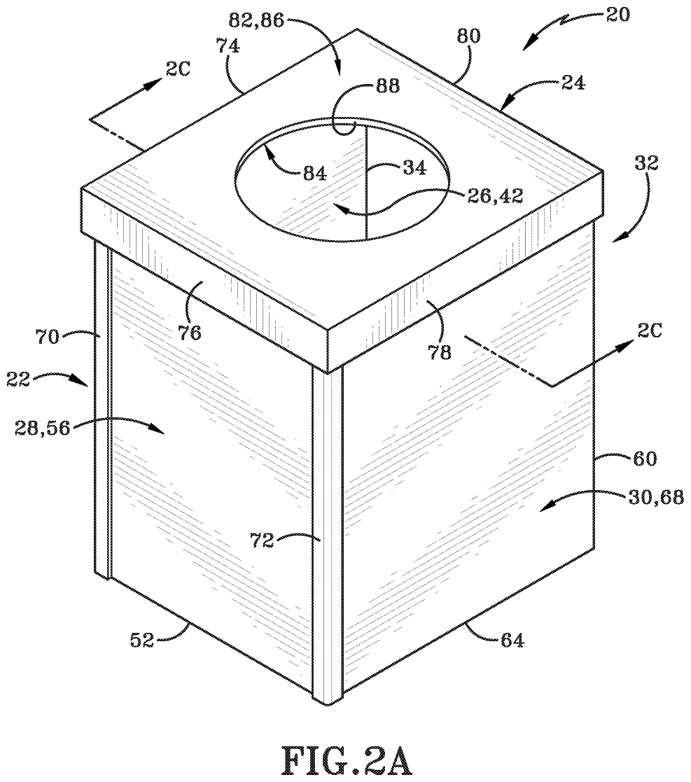

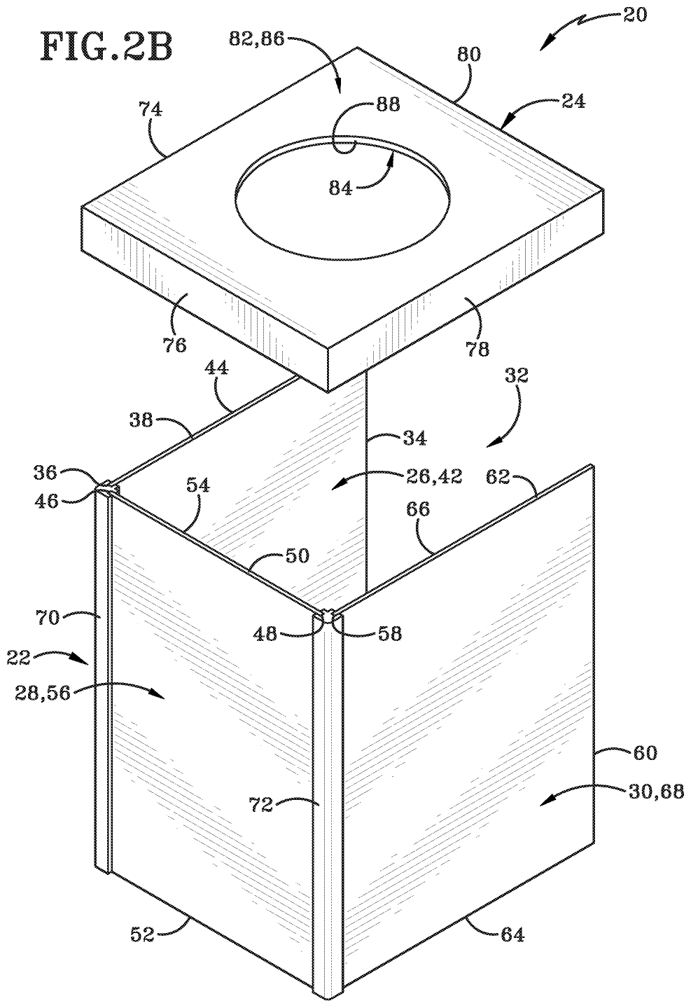

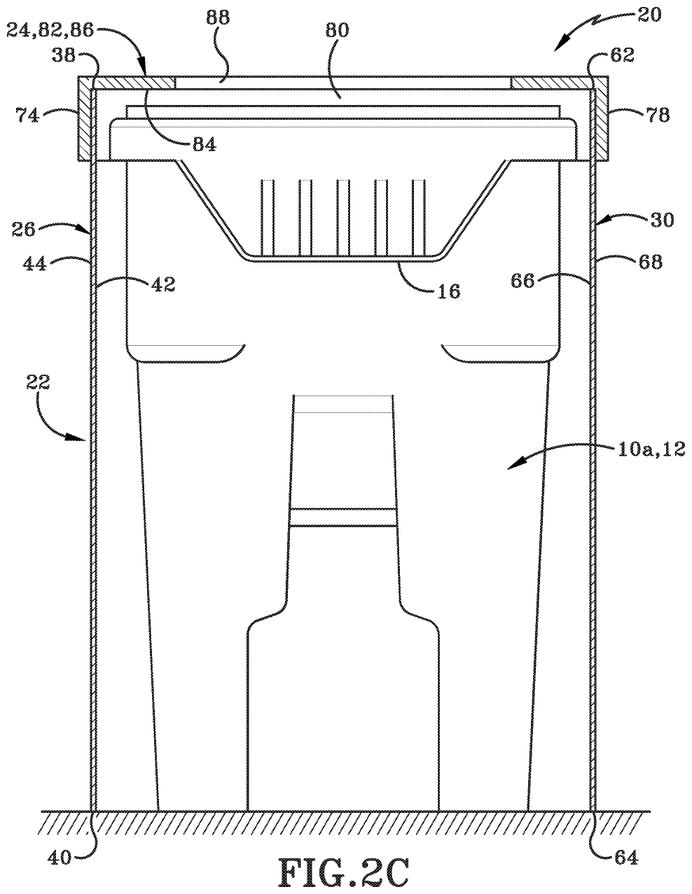

With reference to FIGS. 2A-2C, an embodiment of a system for enclosing a waste receptacle, hereinafter referred to as trash can enclosure, or enclosure, is shown and generally indicated at 20. Trash can enclosure 20 may include a body 22 and a lid 24.

Body 22 of trash can enclosure 20 can include a first side panel 26, second side panel 28, third side panel 30, and open fourth side 32.

First side panel 26 can have a first side edge 34, a second side edge 36, a top edge 38, a bottom edge 40, an inner face 42 and an outer face 44. First side edge 34 can be spaced apart from second side edge 36 and define therebetween a longitudinal direction. Top edge 38 can be spaced apart from bottom edge 40 and therebetween define a vertical direction. Inner face 42 can be the face adjacent the interior of the enclosure 20 when assembled while outer face 44 can face the exterior of the enclosure 20 when assembled.

Second side panel 28 can have a first side edge 46, a second side edge 48, a top edge 50, a bottom edge 52, an inner face 54, and an outer face 56. First side edge 46 can be spaced apart longitudinally from second side edge 48. Top edge 50 can be spaced apart vertically from bottom edge 52. Inner face 54 can be the face adjacent the interior of the enclosure 20 when assembled while outer face 56 can face the exterior of the enclosure 20 when assembled.

Third side panel 30 can have a first side edge 58, a second side edge 60, a top edge 62, a bottom edge 64, an inner face 66, and an outer face 68. First side edge 58 can be spaced apart longitudinally from second side edge 60. Top edge 62 can be spaced apart vertically from bottom edge 64. Inner face 66 can be the face adjacent the interior of the enclosure 20 when assembled while outer face 68 can face the exterior of the enclosure 20 when assembled.

Second side edge 36 of first side panel 26 can be connected to first side edge 46 of second side panel 28 by first corner brace 70. Similarly, second side edge 48 of second side panel 26 can be connected to first side edge 58 of third side panel 30 by second corner brace 72. First and second corner braces 70, 72 can hold side panels 26, 28, and 30 in 90 degree relationships to form three sides of a square or rectangular shaped enclosure 20.

First and second corner braces 70, 72 can be removably attached to the edges 36, 46, 48, and 58 of side panels 26, 28, and 30 by way of vertically oriented channels. Specifically, corner braces 70, 72 can have two U-shaped channels running vertically through the interior of brace 70, 72 that can be sized to receive side edges 36, 46, 48, and 58 of side panels 26, 28, and 30. Channels can be oriented perpendicular to each other to help establish an approximately 90 degree relationship between side panels 26, 28, and 30, as discussed herein. According to one aspect, channels can include a ridge or other similar feature to help keep side edges 36, 46, 48, and 58 of side panels 26, 28, and 30 in place when inserted therein. According to another aspect,

According to this embodiment, fourth side 32 can be open and can be defined as the space between first side edge 34 of first side panel 26 and second side edge 60 of third side panel 30. This open area is best seen in FIG. 2B.

According to this embodiment, when installed around trash can 10, bottom edges 40, 52, and 64 of side panels 26, 28, and 30 can contact the ground and side panels 26, 28, and 30 can extend vertically therefrom, with inner faces 42, 54, and 66 of side panels 26, 28, and 30 oriented towards trash can 10 while outer faces 44, 56, and 68 are oriented away from trash can 10 and are exposed to the elements.

Lid 24 of trash can enclosure 20 can be substantially square or rectangular-shaped and have a first side 74, second side 76, third side 78, and fourth side 80. Lid 24 can further include a top side 82 and a bottom side 84. First, second, third, and fourth sides 74, 76, 78, and 80 can substantially define the perimeter of lid 24 and can have a longitudinal span such that any individual side 74, 76, 78, and 80, can extend slightly beyond the width of any individual side panel 26, 28, or 30 of body 22. First, second, third, and fourth sides 74, 76, 78, and 80 of lid 24 can further have a vertical span that can allow sides 74, 76, 78, and 80 of lid 24 to overlap the uppermost portion of side panels 26, 28, and 30 of body 22, and the uppermost portion of open side 32, when installed.

Top side 82 and bottom side 84 of lid 24 can define a horizontally planar sheet 86 extending between all sides 74, 76, 78, and 80 and connected thereto. Planar sheet 86 can have a thickness less than the vertical span of sides 74, 76, 78, and 80 such that sides 74, 76, 78, and 80 extend downward therefrom to further effect the overlap of side panels 26, 28, and 30. Bottom side 84 of planar sheet 86 can rest on top edges 38, 50, and 62 of side panels 26, 28, and 30 when lid 24 is installed (best seen in FIG. 2C).

Planar sheet 86 can further include a pass-through opening 88 which can allow waste to pass through the planar sheet 86 of lid 24 and into the trash can 10 enclosed therein, provided lid 14 of trash can 10 is removed, or trash can 10 otherwise includes a similarly aligned opening therein to provide access to the interior of body 12 of trash can 10.

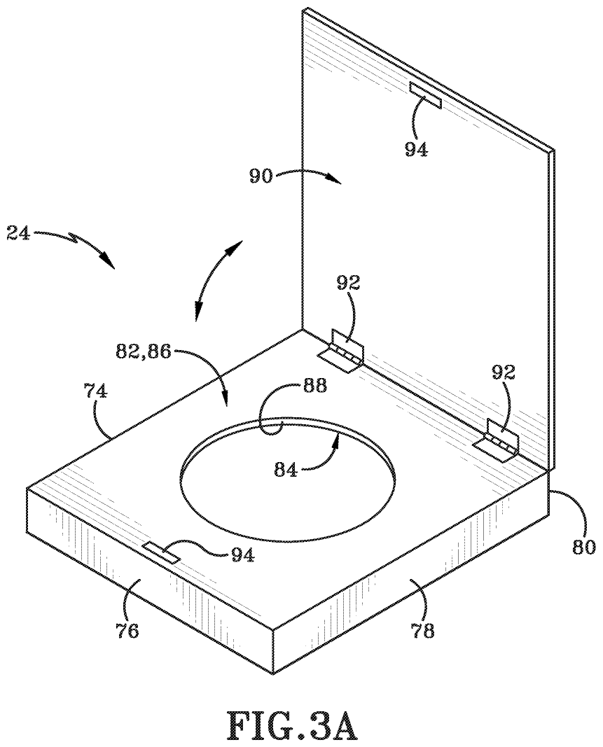

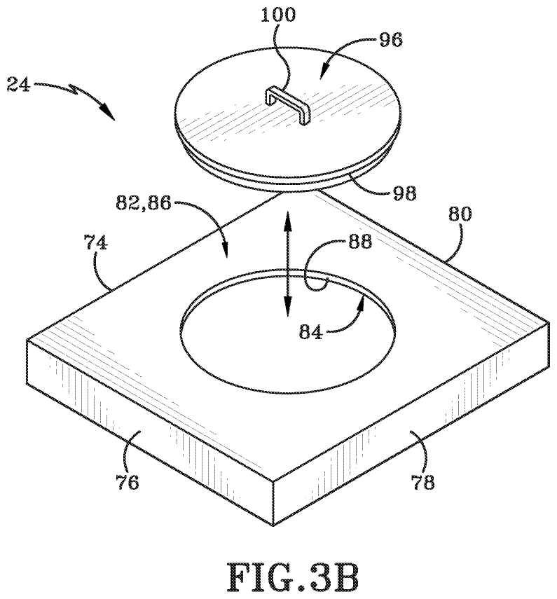

With reference now to FIGS. 3A and 3B, lid 24 is shown having additional optional features included therewith. Specifically and according to the embodiment seen in FIG. 3A, lid 24 can have a cover 90 which can be hingedly attached to top side 82 by one or more hinges 92. Cover 90 and top side 82 can further include a latching mechanism 94 to secure cover 90 in a closed position when not in use. According to one aspect, latching mechanism 94 can be a key lock. According to another aspect, latching mechanism 94 can be a magnetic latch. According to another aspect, latching mechanism 94 can be any known means for securing cover 90 in the closed position over top side 82 of lid 24.

According to another embodiment, as seen in FIG. 3B, lid 24 can alternatively include pass-through opening 88 which can be sealed by means of a plug 96 which is sized to fit within pass-through opening 88 and can be secured to top side 82 of lid 24 prevent plug 96 from falling through pass-through opening 88 and into the trash can 10 below. According to one aspect, plug 94 can include a lip 96 that extends beyond the outer circumference of pass-through opening 88 to prevent plug 94 from falling through opening 88. According to another aspect, pass-through opening 72 can include a rim upon which plug 94 can sit. Plug 94 can include a handle 100 to allow easy installation and removal thereof. According to one aspect, handle 100 can retract into plug 94 to maintain a flush surface when installed on lid 24.

According to another embodiment, lid 24 can have a solid planar sheet 86 with a top side 82 and bottom side 84, but with pass-through opening 88 omitted.

According to one embodiment, lid 24 or alternate embodiments thereof, can be placed on body 22 to cover trash can 10 enclosed within trash can enclosure 20. Securing mechanisms for lid 24 can include internal ridges or latching mechanisms (not shown) that can interact with similar ridges or locking mechanisms (not shown) disposed on body 22. According to another aspect, lid 24 can be hingedly attached to one or more side panels 26, 28, or 30, of body 22. According to another aspect, lid 24 can include a lock or locking mechanism (not shown) to secure lid 24 to body 22 when installed over an associated trash can 10.

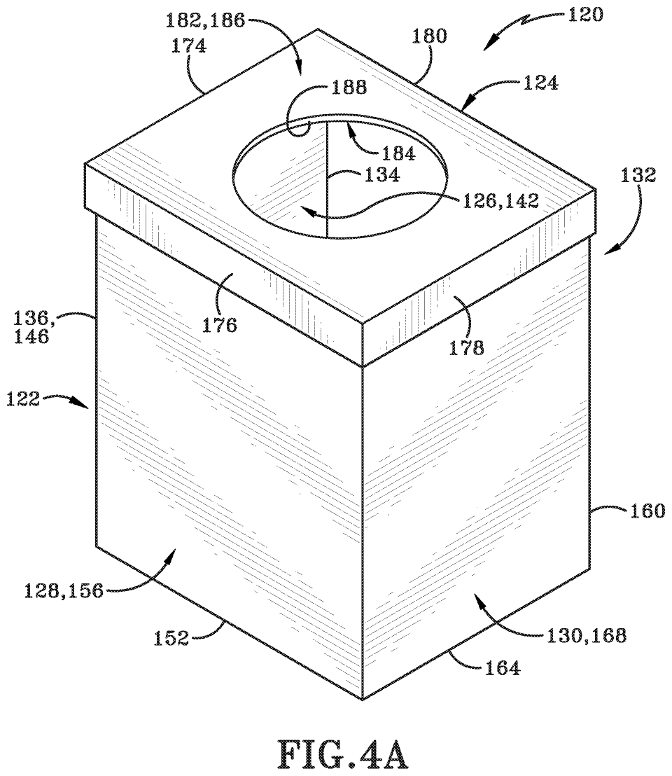

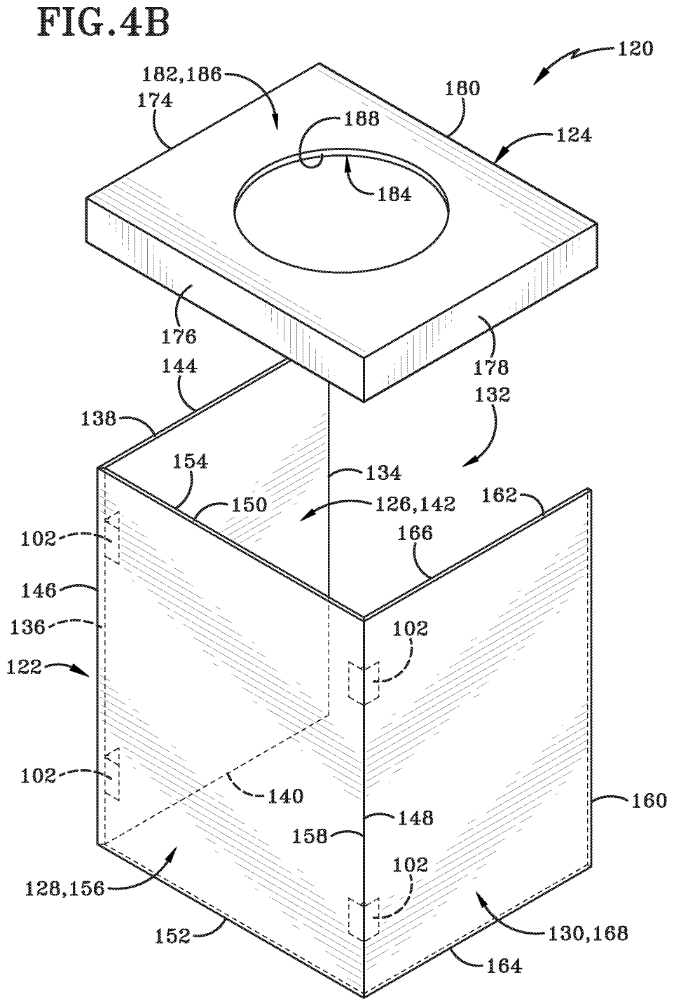

With reference now to FIGS. 4A and 4B, an alternative embodiment of trash can enclosure 20 is shown and referenced as enclosure 120. Enclosure 120 can have similar components and features as enclosure 20 except that according to this embodiment, first side panel 126, second side panel 128, and third side panel 130 are connected through internal hinges 102 and corner braces 70 and 72 of enclosure 20 are omitted. The use of internal hinges 102 can allow the second side edge 136 of first side panel 126 to contact the first side edge 146 of second side panel 128 directly. Similarly, second side edge 148 of second side panel 128 can contact first side edge 158 of third side panel 130 directly. This can create a cleaner, more uniform appearance of body 122 of enclosure 120. Further, the use of internal hinges 102 can allow side panels 126, 128, and 130 to be folded or rotated about a vertical axis relative to each other to allow easy adjustment, movement, or storage. The installation and operation of enclosure 120 is further discussed below.

According to one alternative aspect, internal hinges 102 can be replaced by one or more brackets that can secure side panels 126, 128, and 130 to one another without permitting movement therebetween. By way of one non-limiting example, brackets can be L-braces.

Lid 124, as shown according to this embodiment, can be substantially identical to lid 24, as described herein, and may optionally include one or more of the additional features shown and described with reference to FIGS. 3A and 3B, as chosen by a person of skill in the art.

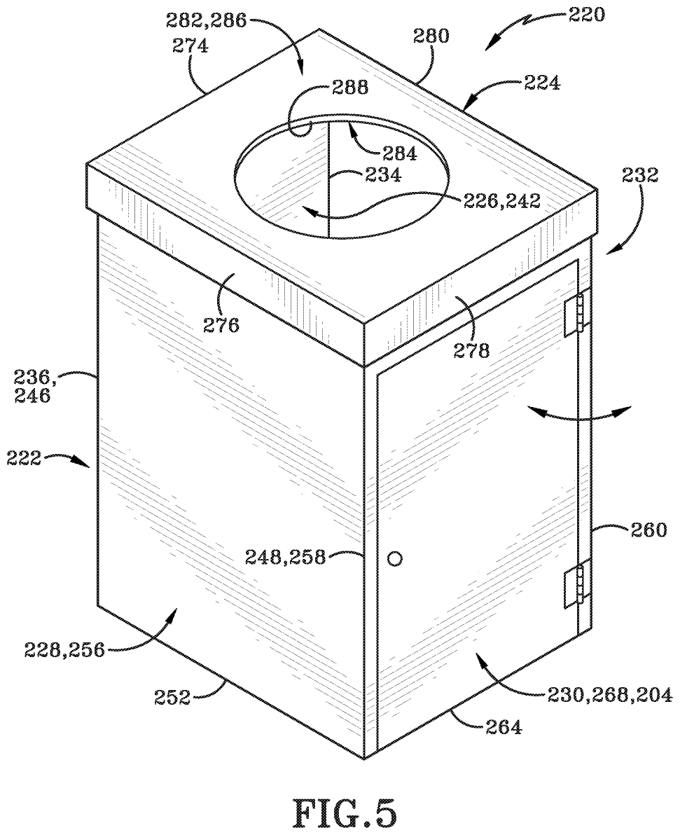

With reference to FIG. 5, another alternative embodiment of enclosure 20 is shown and indicated as enclosure 220. Enclosure 220 may differ from enclosure 20 or 120 in that enclosure 220 may include a door 204 hingedly attached to one or more of the side panels 226, 228, and 230. According to one aspect, enclosure 220 can have a fourth side panel (not shown) in place of open fourth side 32. According to this aspect, fourth side panel can have similar features to side panels 226, 228, 230 and can be operationally connected thereto. Specifically, fourth side panel can have a first side edge, a second side edge, a top edge, a bottom edge, an inner face, and an outer face. First side edge of fourth side panel can connect to second side edge 260 of third side panel 230 while second side edge of fourth side panel can connect to first side edge 234 of first side panel 226. Inner face of fourth side panel can be adjacent to rear side of trash can 10. Further according to this aspect, door 204 can be hingedly attached to fourth side panel.

Further according to this embodiment, side panels 226, 228, 230, and optional fourth side panel to be connected with corner braces, hinges, or permanent brackets. According to one aspect, the presence of door 204 can allow the side panels 226, 228, 230, and optional fourth side panel, to be fixed relative to one another as access to the interior and to a trash can 10 enclosed therein is provided through door 204. According to another aspect, side panels 226, 228, 230, and optional fourth side panel can have a latching mechanism between one or more of panels 226, 228, 230, and optional fourth panel that can allow side panels 226, 228, 230, and optional fourth side panel to disconnect from one another for quick and easy removal of trash can enclosure 220 from around trash can 10. The latching mechanism for the side panels, according to this embodiment, can be any latch as chosen by a person of skill in the art suitable for the intended use thereof.

Lid 224, as shown according to this embodiment, can likewise be substantially identical to lid 24, as described herein, and may optionally include one or more of the additional features shown and described with reference to FIGS. 3A and 3B, as chosen by a person of skill in the art.

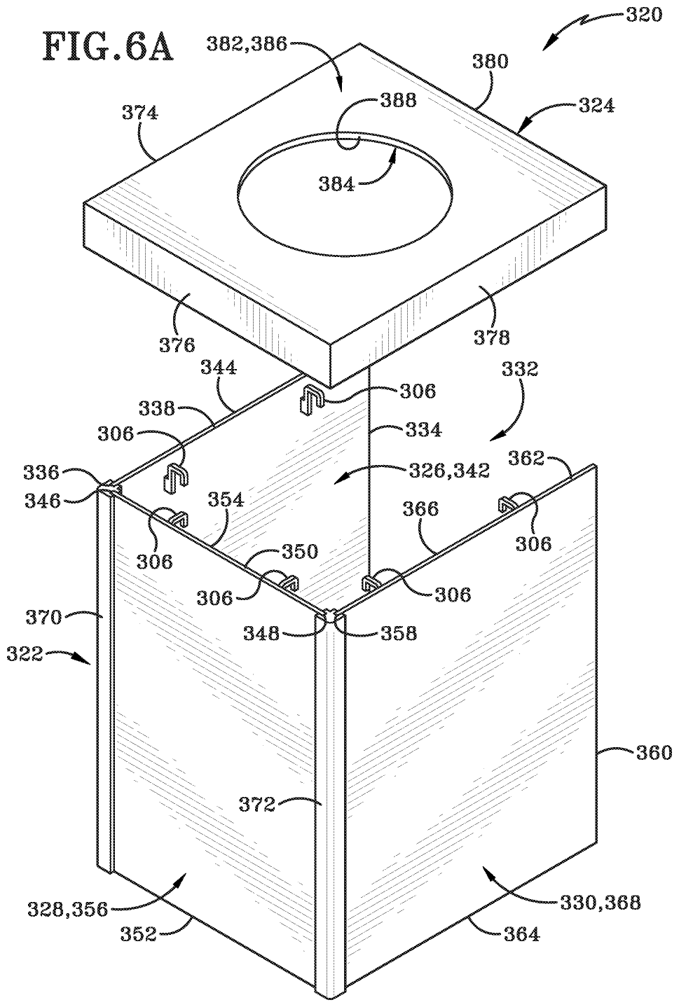

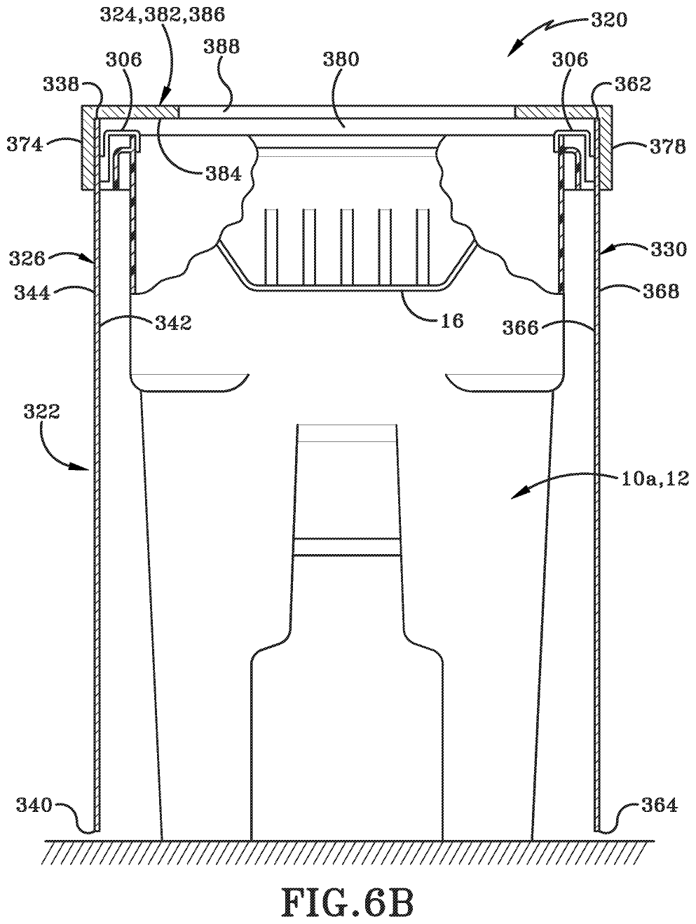

With reference to FIGS. 6A and 6B, another alternative embodiment of trash can enclosure 20 is shown and generally indicated at 320. According to this embodiment, trash can enclosure 320 can have similar components and features as enclosure 20 except that according to this embodiment, body 320 can further include a series of clips or fasteners 306 connected inner face 342, 354 and 366 of side panels 326, 328, and 330 near top edges 338, 350, and 362, respectively. These fasteners 306 can be configured to hang or otherwise attach side panels 326, 328, and 330 to the edge of an associated trash can 10 as seen in FIG. 6B. This can allow side panels 326, 328, and 330 to hang from trash can 10 and remain mobile with trash can 10, allowing trash can 10 and trash can enclosure 320 to be moved as a single unit. This can further help to secure side panels 326, 328, and 330 in place around trash can 10 to resist disturbance from weather or contact with trash can enclosure 320 by persons or animals. According to this aspect, side panels 326, 328, and 330, can have a vertical height that is less than or equal to the vertical height of trash can 10 such that the bottom edges 340, 352, and 364 of side panels 326, 328, and 330 are suspended just above the ground surface upon which the trash can 10 sits. This can allow additional mobility of the trash can 10 and enclosure 320 without the need to remove panels 326, 328, and/or 330 from the trash can 10 before movement.

According to one aspect, fasteners 306 can include a series of hooks or J-shaped clips which can hang from the upper edge of a trash can 10 associated therewith. According to another aspect, fasteners 306 can be proprietary to the specific brand and model of trash can 10 around which enclosure 320 is to be installed. According to this aspect, fasteners 306 would interact with a surface on trash can 10 to secure side panels 326, 328, and 330 to trash can 10.

Lid 324, as shown according to this embodiment, can likewise be substantially identical to lid 24, as described herein, and may optionally include one or more of the additional features shown and described with reference to FIGS. 3A and 3B, as chosen by a person of skill in the art.

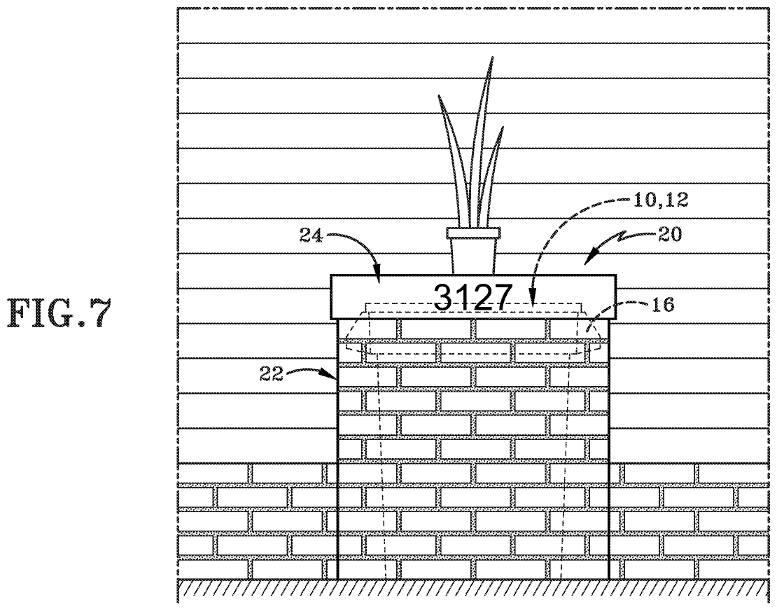

With reference to FIG. 7, outer faces 44, 56, and 68 of side panels 26, 28, and 30 of trash can enclosure 20, 120, 220, or 320 can be decorative faces styled to blend in with surroundings. According to one aspect and as shown in FIG. 7, outer faces 44, 56, and 68 can be styled to appear to be constructed of brick. According to another aspect, outer faces 44, 56, and 68 can appear as stone, siding such as vinyl or aluminum, concrete, or any other commonly used construction material or siding material. According to this aspect, it will be understood that multiple designs of outer faces 44, 56, and 68 of trash can enclosure 20, 120, 220, or 320 may be utilized to best match the desired installation conditions. By way of a non-limiting example, a home with a vinyl or wood-panel siding material on an upper portion and a stone or brick material on a lower portion may use a trash can enclosure 20, 120, 220, or 320 of the present disclosure having an upper portion matching the siding portion with a lower portion matching the brick or stone portion. It will be further understood that various design and aesthetic elements can be equally applied to all embodiments of enclosure 20, 120, 220, or 320 described herein.

Although presented herein with reference to multiple embodiments, it will be understood that features from any embodiment may be adapted or included with any other embodiment without deviation from the scope as described herein. By way of one non-limiting example, any embodiment of enclosure 20, 120, 220, or 320 of disclosed herein can utilize optional fourth side panel in place of open fourth side 32.

Further, connections described herein between side panels 26, 28, and 30, and all embodiments thereof, can be adapted for use with any embodiment. Alternatively, side panels 26, 28, 30, and all embodiments thereof can be constructed from of a single continuous piece of material. According to one aspect, this material can be formed with the proper fixed position between side panels. According to another aspect, this continuous material can be hinged or otherwise formed to permit repetitive folding of side panels 26, 28, and 30 via a living hinge, and all embodiments thereof relative to each other.

It will be further understood that various design and aesthetic elements can be equally applied to all embodiments of enclosure 20 described herein.

Any and all components of enclosure 20 and all embodiments thereof can be manufactured by any suitable means and from any material suitable for the desired application, including but not limited to, plastic, metal, vinyl, wood, or a combination thereof, as chosen by a person of skill. According to one aspect, enclosure 20, 120, 220, or 320 and all embodiments and components thereof can be rotationally molded out of plastic.

Having thus described the individual elements of the present disclosure, the operation will now be discussed.

With reference to FIGS. 2A-2C, a first embodiment of trash can enclosure 20 is shown with a trash can 10a enclosed therein. FIG. 2C shows second side panel 28 of enclosure 20 cut away to better illustrate how enclosure 20 can operate. Though shown with trash can 10a, it will be understood that enclosure 20 can be sized and configured to accept any trash can 10 or other receptacle as chosen by a person of skill.

According to this embodiment, body 22 of enclosure 20 can be placed around trash can 10 with first side panel 26 aligned adjacent to and parallel with one side of trash can 10, second side panel 28 (omitted from FIG. 2C) aligned adjacent to and parallel with front of trash can 10, and third side panel 30 aligned adjacent to and parallel with the opposite side of trash can 10 from first side panel 26 thereby enclosing trash can 10 on three sides. Open fourth side 32 can be aligned with rear of trash can 10. First, second, and third side panels 26, 28, and 30 can be connected by first and second corner braces 70, 72 (also omitted from FIG. 2C). According to one aspect, first corner brace 70 can snap into place on second side edge 36 of first side panel 26 and first side edge 46 of second side panel 28 via the U-shaped channels included therein. Similarly, second corner brace 72 can snap into place on second side edge 48 of second side panel 28 and first side edge 58 of third side panel 30 via the U-shaped channels included therein. Corner braces 70, 72, by virtue of the orthogonal orientation of U-shaped channels, can hold side panels 26, 28, and 30 together with an approximate 90 degree angle giving body 22 of enclosure 20 a generally square or rectangular shape.

Once side panels 26, 28, and 30 are assembled with corner braces 70, 72, lid 24 can be removably placed on top of body 22 with bottom side 84 of planar sheet 86 resting on top edges 38, 50, and 62 of side panels 26, 28, and 30, respectively. First side 74 of lid 24 can be adjacent and exterior of first side panel 26, second side 76 of lid 24 can be adjacent and exterior of second side panel 28, third side 78 of lid 24 can be adjacent and exterior of third side panel 30, and fourth side 80 of lid 24 can span the top portion of the open fourth side 32. According to one aspect, lid 24 can slidably engage body 22 and can optionally include locking features to secure lid 24 to body 22, as discussed above.

According to one aspect, lid 14 of trash can 10 can remain in place while trash can 10 is contained within enclosure 20 and can be opened and/or removed to allow access into body 12 of trash can 10. According to another aspect, lid 14 of trash can 10 can be removed while trash can 10 is contained within enclosure 20.

All described embodiments of lid 24 can be utilized with enclosure 20. For embodiments of lid 24 having pass-through opening 88 omitted, lid 24 can be removed to allow access to the trash can 10 and lid 24 can be replaced when access is no longer desired.

When embodiments of lid 24 having pass-through opening 88 present are utilized, lid 24 can remain in place on top of body 22 while pass-through opening 88 can allow direct access to trash can 10 within enclosure 20, again provided lid 14 of trash can 10 is removed, or trash can 10 otherwise includes a similarly aligned opening therein to provide access to the interior of body 12 of trash can 10.

With installations where lid 24 is equipped with cover 90, a user can rotate cover 90 about hinges 92 to lift cover 90 out of the way of pass-through opening 88, thus allowing access to trash can 10. Once access to trash can 10 is no longer desired, cover 90 can be closed. If equipped with a latching mechanism 94, a user must first defeat the latching mechanism 94 prior to opening cover 90, and must re-engage latching mechanism upon closing of cover 90.

With installations where lid 24 is equipped with plug 96, a user can grasp the handle 100 of plug 96 and can pull directly upwards to remove plug 96 from pass-through opening 88 to gain access to trash can 10. Once access is no longer desired, plug 96 can be replaced within pass-through opening 88.

Placement and removal of trash can 10 within enclosure 20 can be accomplished in multiple ways. First, enclosure 20 can be assembled around a stationary trash can 10, as described above. Alternatively, side panels 26, 28, and 30 of enclosure 20 can be assembled and trash can 10 can be moved into enclosure 20 through open fourth side 32 prior to placing lid 24 on body 22. Removal of trash can 10 can likewise be accomplished by disassembling enclosure 20 from around trash can 10, or by removing lid 24 from body 22 and moving trash can 10 out of enclosure 20 through open fourth side 32.

With reference now to FIG. 4B, enclosure 120 is shown. As discussed above, enclosure 120 differs from enclosure 20 in that side panels 126, 128, and 130 are connected by way of internal hinges 120. According to this embodiment, side panels 126, 128, and 130 can be installed around a trash can 10 by opening first and third side panels 126 and 130 relative to second side panel 128 to form the three sided body 122, which can be placed around three sides of a trash can 10, with first side panel 126 aligned adjacent to and parallel with one side of a trash can 10, second side panel 128 aligned adjacent to and parallel with front of a trash can 10, and third side panel 130 aligned adjacent to and parallel with the opposite side of a trash can 10 from first side panel 126. Open fourth side 132 can be aligned with the rear of a trash can 10.

As with enclosure 20, enclosure 120 can be assembled around a stationary trash can 10, or alternatively, trash can 10 can be placed within assembled enclosure 120 prior to placing lid 24 on body 122 of enclosure 120. Similarly, removal of trash can 10 from within enclosure 120 can be accomplished by disassembling enclosure 120 from around trash can 10, or by alternatively removing trash can 10 from enclosure 120 through open fourth side 132.

Lid 24, including all embodiments thereof, can interact with enclosure 120 in a manner substantially identical to that which has been described herein with regards to enclosure 20.

With reference now to FIG. 5, enclosure 220 can operate substantially similar to enclosures 20 and 120 in that side panels 226, 228, and 230 can be placed around trash can 10 in a substantially identical manner. Alternatively, as discussed above, enclosure 220 can have door 204 hingedly attached to one or more side panels 226, 228, or 230. Further, enclosure 220 can have a fourth side panel in place of open fourth side 232 which could also include a door 204.

In instances where enclosure 220 does not include the optional fourth side, trash can 10 can be placed or removed from enclosure 220 through assembling/disassembling enclosure 220 around trash can 10, or by placement and removal of trash can 10 through open fourth side 232, as described before with regards to enclosures 20 and 120. Trash can 10 can further be accessed, placed, and/or removed through door 204.

In instances where enclosure 220 includes optional fourth side, trash can 10 can be placed or removed from enclosure 220 through assembly/disassembly of enclosure 220, or through door 204.

As with enclosure 120, lid 24, including all embodiments thereof, can interact with enclosure 220 in a manner substantially identical to that which has been described herein with regards to enclosure 20.

With reference to FIGS. 6A and 6B installation and removal of enclosure 320 on a trash can 10 (shown in FIG. 6B as trash can 10a) can be accomplished according to the following methods. Side panels 326, 328, and 330 can be affixed to the upper rim or uppermost surface of trash can 10 by way of fasteners 306. Specifically, first side panel 326 can be affixed to and thereby hang from one side of trash can 10, second side panel 328 (omitted from FIG. 6B) can be affixed to and thereby hang from front of trash can 10, and third side panel 330 can be affixed to and thereby hang from the opposite side of trash can 10 from first side panel 26 thereby enclosing trash can 10 on three sides. Open fourth side 332 can be aligned with rear of trash can 10. First, second, and third side panels 326, 328, and 330 can be connected by first and second corner braces 370, 372 (also omitted from FIG. 6B). According to one aspect, first corner brace 370 can snap into place on second side edge 336 of first side panel 326 and first side edge 346 of second side panel 328 and second corner brace 372 can snap into place on second side edge 348 of second side panel 328 and first side edge 358 of third side panel 330. Corner braces 370, 372 can hold side panels 326, 328, and 330 together with a 90 degree angle giving body 322 of enclosure 320 a generally square or rectangular shape.

The fasteners 306 can engage the top edge of trash can 10 thereby allowing side panels 326, 328, and 330 to hang from the uppermost edge of trash can 10 and extend nearly to the base of trash can 10, terminating just above the ground surface upon which the trash can 10 is placed. This can allow a degree of ground clearance which can in turn allow trash can 10 to be maneuvered about while enclosure 320 is installed, thereby permitting trash can 10 and enclosure 320 to function as a single unit.

According to one embodiment, for installation of enclosure 320 on a trash can 10 with a circular body 12, such as trash can 10b, fasteners 306 can engage a frame (not shown) that is sized to fit within enclosure 320 and engaged to fasteners 306 on a first side while having an interior size and shape configured to engage the rim of a trash can 10 with a circular body 12, such as trash can 10b. By way of one non-limiting example, frame can have a square or rectangular member around its perimeter to engage fasteners 306 with a circular member contained within the square/rectangular member to engage trash can 10. According to one aspect, circular member can further include a series of fasteners 306.

It will be further understood that frame, described herein to allow connection of enclosure 320 to a round trash can 10, can be sized and/or configured to permit connection between enclosure 320 and a trash can 10 with a body 12 having any other shape or configuration.

According to another embodiment, fasteners 306 can be inverted and configured to support trash can 10 within enclosure 320.

As with enclosures 120 and 220, lid 24, including all embodiments thereof, can interact with enclosure 320 in a manner substantially identical to that which has been described herein with regards to enclosure 20.

According to one aspect, lid 24, as installed on enclosure 320 can further help to prevent fasteners 306 from dislodging during use or movement of trash can 10.

With reference to FIG. 7, it is contemplated that enclosures 20, 120, 220, or 320 can be placed against a wall of a structure, such as a home, garage, outbuilding, or other similar structures. For embodiments having an open fourth side 32, it is further contemplated that enclosures 20, 120, 220, or 320 can be oriented such that open fourth side 32 is adjacent the structure with first side edge 34, 134, 234, or 334 of first side panel 26, 126, 226, 326 and second side edge 52, 152, 252, and 352 of third side panel 30, 130, 230, or 330 would be in contact with the structure thereby completely enclosing and concealing trash can 10 within body 22, 122, 222, or 322, with the associated structure essentially forming a back wall of the enclosure 20, 120, 220, or 320. For embodiments having an optional fourth side panel, it is contemplated that enclosures 20, 120, 220, or 320 can be oriented such that optional fourth side panel is adjacent to and in contact the structure.

This configuration and orientation can allow enclosures 20, 120, 220, or 320 to further blend in to the surrounding, thus increasing the aesthetic value of enclosures 20, 120, 220, or 320.

It is further contemplated that embodiments of enclosures 20, 120, 220, or 320 having the optional fourth side panel can be placed in open areas, thus allowing trash can 10 and enclosures 20, 120, 220, or 320 to be utilized in freestanding or other similar installations away from an associated structure while effectively hiding trash can 10 from view. Examples of such installations can include a middle of a yard, a deck, patio, a park, a school, a curbside or sidewalk, a walking trail, public buildings, outdoor venues, or other similar environments.

In further operation, and applicable to all embodiment of enclosures 20, 120, 220, or 320, the combination of enclosures 20, 120, 220, or 320, and lid 24 can create a tamper-resistant seal between lid 24 and enclosures 20, 120, 220, or 320. This interaction of enclosures 20, 120, 220, or 320, with lid 24, particularly those embodiments of lid 24 having a cover 90 or plug 96, can help reduce or eliminate intrusions by insects or other wildlife, e.g. raccoons.

It will be further understood that the materials used for construction of enclosures 20, 120, 220, or 320, and lid 24 can be of sufficient thickness and/or density to help reduce or eliminate the emanation of unpleasant odors from the contents of trash can 10 while contained within enclosures 20, 120, 220, or 320.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A waste receptacle enclosure comprising:
a first side panel having a first side edge, a second side edge, a top edge, a bottom edge, an inner face and an outer face;
a second side panel having a first side edge, a second side edge, a top edge, a bottom edge, an inner face and an outer face, wherein the first side edge of the second panel is connected to the second side edge of the first side panel and oriented 90 degrees thereto;
a third side panel having a first side edge, a second side edge, a top edge, a bottom edge, an inner face and an outer face; wherein the second side edge of the second panel is connected to the first side edge of the third side panel and oriented 90 degrees thereto;
a lid having a first side, a second side, a third side, a fourth side, and a planar sheet connecting each of the sides, the planar sheet further having a top side and a bottom side, wherein the bottom side of the planar sheet rests upon the top edges of the first, second, and third side panels; and
a waste receptacle contained between the first, second, and third side panels.

2. The enclosure of claim 1 wherein the lid further comprises a pass-through opening operable to allow access to the trash can contained therein.

3. The enclosure of claim 2 wherein the lid further comprises a cover hingedly attached thereto and operable to seal pass-through opening when not in use.

4. The enclosure of claim 2 wherein the lid further comprises a plug operable to seal pass-through opening when not in use.

5. The enclosure of claim 1 wherein the outer face of the first, second, and third side panels further comprise decorative faces.

6. The enclosure of claim 1 further comprising internal hinges operable to connect first side panel to second side panel and second side panel to third side panel.

7. The enclosure of claim 6 further comprising a vertical pivot axis enabling the first and third side panels can pivot relative to the second side panel from a folded position to a 90 degree angle relative to second side panel.

8. The enclosure of claim 1 further comprising:
a fourth side panel having a first side edge, a second side edge, a top edge, a bottom edge, an inner face, and an outer face, wherein the first side edge of the fourth panel is connected to the second side edge of the third side panel and oriented 90 degrees thereto and the second side edge of the fourth panel is connected to the first side edge of the first side panel and oriented 90 degrees thereto.

9. The enclosure of claim 8 wherein the outer face of the fourth side panel further comprises:
a decorative face.

10. The enclosure of claim 8 further comprising:
internal hinges operable to connect fourth side panel the first and third side panels.

11. The enclosure of claim 10 wherein the fourth side panel further comprises:
a door hingedly attached thereto.

12. The enclosure of claim 1 wherein the first, second, and third side panels further comprise:
a plurality of fasteners operable to connect first, second, and third side panels to the trash can.
